(19) United States
(12) Patent Application Publication
(10) Pub. No.: US 2014/0112807 A1
(43) Pub. Date: Apr. 24, 2014

(54) MOTOR PROTECTION STRUCTURE

(71) Applicant: ASIA VITAL COMPONENTS CO., LTD., New Taipei City (TW)

(72) Inventors: Wei-Cheng Chen, New Taipei City (TW); Ping-Chi Kuo, New Taipei City (TW); Chu-Hsien Chou, New Taipei City (TW); Shih-Chieh Lin, New Taipei City (TW)

(73) Assignee: ASIA VITAL COMPONENTS CO., LTD., New Taipei City (TW)

(21) Appl. No.: 13/657,873

(22) Filed: Oct. 23, 2012

(51) Int. Cl. H02K 5/10; F04D 25/08; F04D 29/32

(52) U.S. Cl. 417/423.7; 310/45; 310/88

(57) ABSTRACT

A motor protection structure includes a stator assembly, a casing and a filling material. The stator assembly is coated with a coating and fitted on one side of the casing. The casing has a receiving space for receiving a circuit board. The filling material is filled in the receiving space to enclose the circuit board. The filling material is connected to the coating to fully seal the stator assembly and the casing so as to lower manufacturing cost and shorten working time.

### BACKGROUND OF THE INVENTION

1. Field of the Invention

The present invention relates to a motor protection structure, which can greatly lower manufacturing cost and shorten working time.

2. Description of the Related Art

Cooling fans have been more widely and more widely applied in various fields. Some cooling fans are specifically applied to special-usage electronic apparatuses such as CPU, server, power supply, telecommunication chassis and telecommunication base station. In some cases, the environment of the application site of the cooling fan is quite severe so that the conventional cooling fan can be hardly used in such environment. The circuit board and bearing cup seat of the conventional cooling fan are not equipped with any waterproof and anti-salty fog structure. As a result, when used in a humid environment with salty fog, the salty fog is likely to accumulate on the internal circuit board and bearing cup seat of the cooling fan. Under such circumstance, the cooling fan often clogs and fails to normally operate. Therefore, the lifetime of the cooling fan is shortened.

A glue pouring technique has been disclosed by those who are skilled in this field. In such glue pouring technique, the stator assembly and the circuit board are first assembled on the outer frame of the fan. Then, these components are respectively placed into a mold. Then glue is filled into the mold. After the glue is solidified, these components are taken out from the mold. Accordingly, the stator assembly and the circuit board are coated with a layer of glue and the interior of the bearing cup seat is filled up with the glue to achieve waterproof and anti-salty fog effect. In the conventional method, a large amount of material is consumed and it is necessary to expend extra cost for making the mold for performing the glue pouring process to enclose the stator assembly. As a result, the manufacturing cost is much higher and the working time is much longer.

According to the above, the conventional technique has the following shortcomings:

1. The manufacturing cost is increased.

2. The working time is longer.

3. The weight is heavier.

4. The heat can be hardly dissipated.

It is therefore tried by the applicant to provide a motor protection structure to solve the above problems existing in the conventional technique.

### SUMMARY OF THE INVENTION

It is therefore a primary object of the present invention to provide a motor protection structure, which can lower manufacturing cost.

It is a further object of the present invention to provide the above motor protection structure, which can shorten the working time.

To achieve the above and other objects, the motor protection structure of the present invention includes a stator assembly, a casing and a filling material. The stator assembly has multiple silicon steel sheets and multiple windings. The stator assembly is coated with a coating. The casing has a receiving space for receiving a circuit board electrically connected to the windings. The stator assembly is fitted on one side of the casing. The filling material is filled in the receiving space to enclose the circuit board. The filling material is connected to the coating to seal the stator assembly and the casing. Under such circumstance, impurities such as humidity and dust are prevented from infiltrating into the circuit board and internal electronic components. Accordingly, the circuit board and the internal electronic components are protected from damage and the weight can be reduced and the heat can be more easily dissipated. In the conventional technique, it is necessary to use a large amount of glue material and expend extra cost for making the mold. The motor protection structure of the present invention is free from these shortcomings so that the manufacturing cost is lowered and the working time is shortened.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIG. 1 is a perspective exploded view of a preferred embodiment of the motor protection structure of the present invention;

FIG. 2 is a perspective assembled view of the preferred embodiment of the motor protection structure of the present invention; and

FIG. 3 is a sectional view of the preferred embodiment of the motor protection structure of the present invention.

### DETAILED DESCRIPTION OF THE PREFERRED EMBODIMENT

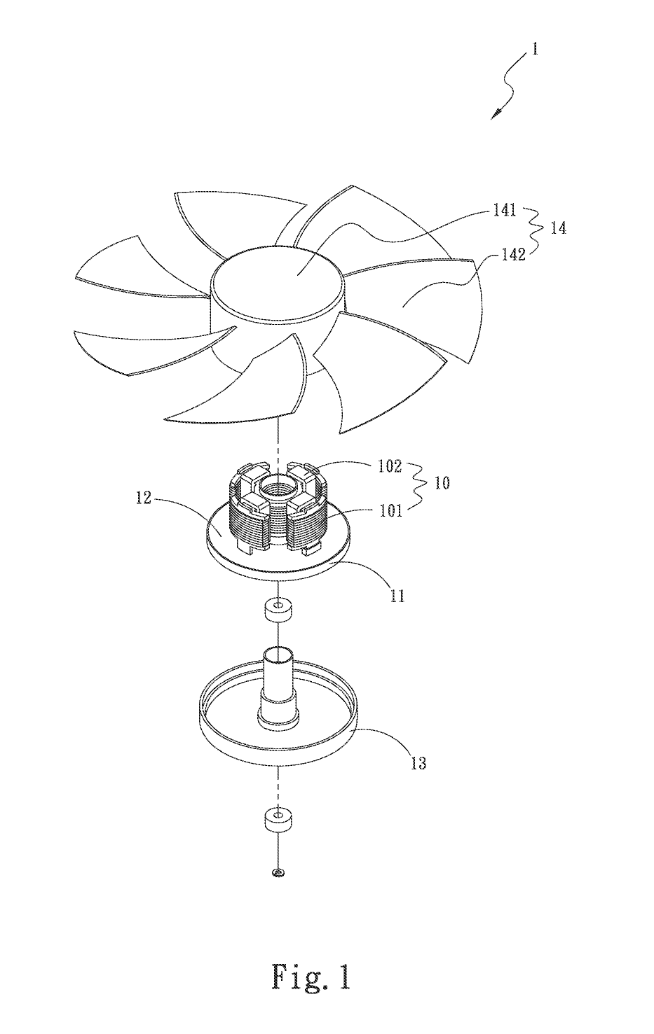

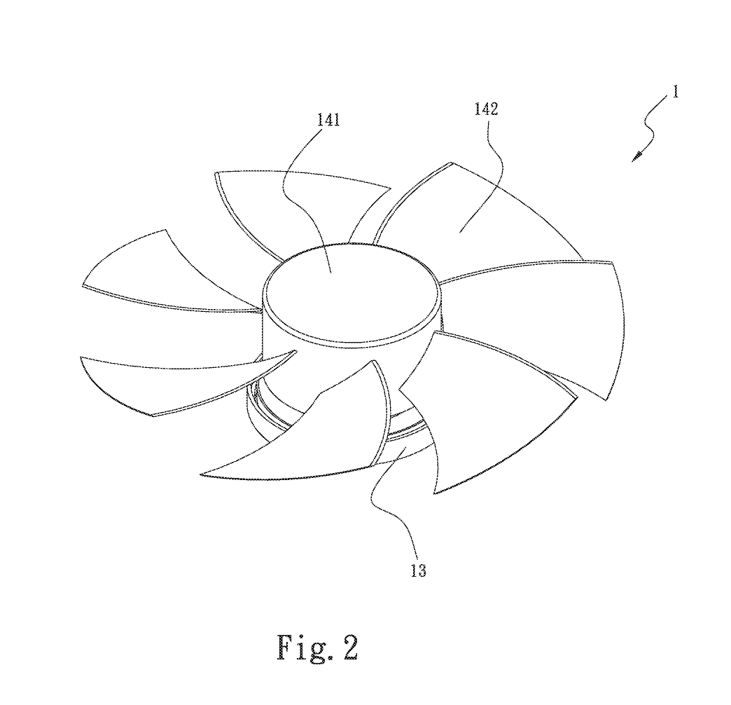

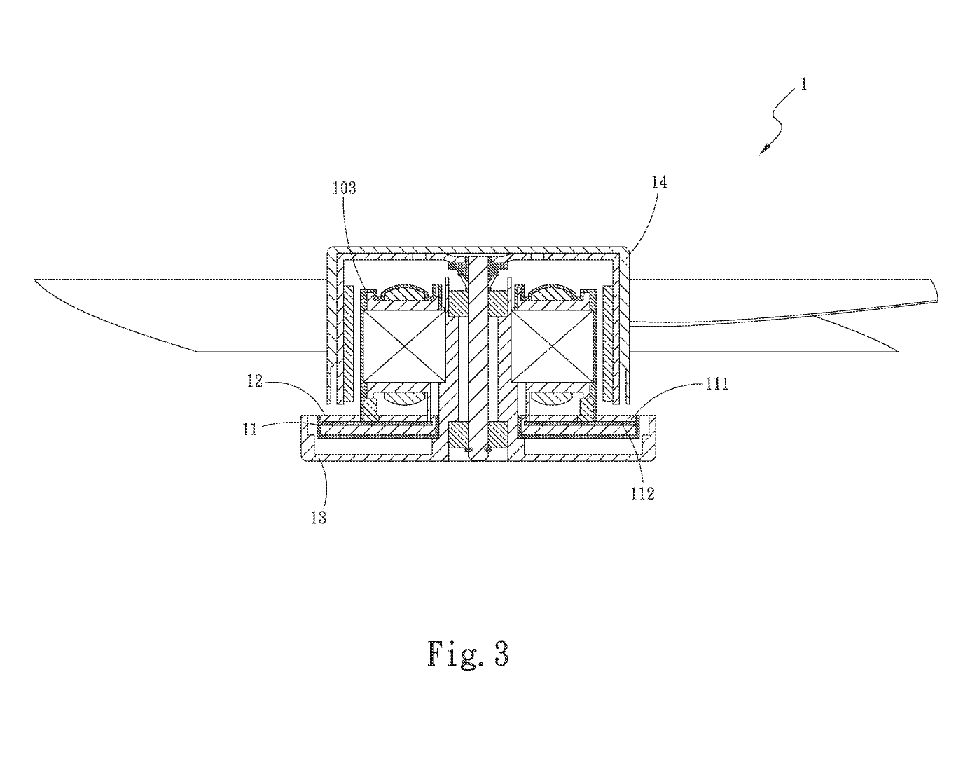

Please refer to FIGS. 1, 2 and 3. FIG. 1 is a perspective exploded view of a preferred embodiment of the motor protection structure of the present invention. FIG. 2 is a perspective assembled view of the preferred embodiment of the motor protection structure of the present invention. FIG. 3 is a sectional view of the preferred embodiment of the motor protection structure of the present invention. According to the first embodiment, the motor protection structure 1 of the present invention includes a stator assembly 10, a casing 11 and a filling material 12. The stator assembly 10 has multiple silicon steel sheets 101 and multiple windings 102. The stator assembly 10 is coated with a coating 103. The coating 103 is formed and coated on the stator assembly 10 by means of physical vapor deposition or chemical vapor deposition. The physical vapor deposition is selected from a group consisting of vacuum evaporation, sputtering evaporation and ion evaporation.

The casing 11 has a receiving space 111 for receiving a circuit board 112 electrically connected to the windings 102. The stator assembly 10 is fitted on one side of the casing 11. The casing 11 is made of polymer material.

The filling material 12 is filled in the receiving space 111 to enclose the circuit board 112. The filling material 12 is connected to the coating 103 to seal the stator assembly 10 and the casing 11. The filling material 12 is selected from a group consisting of silicone, polyurethane, epoxy resin, liquid, fluid material and waterproof material.

The motor protection structure 1 of the present invention further includes a bearing cup seat 13 and a fan impeller 14. The bearing cup seat 13 is disposed on the other side of the casing 11, which side is distal from the stator assembly 10. The fan impeller 14 is capped on the stator assembly 10 and has a hub 141 and multiple blades 142. The blades 142 are annularly arranged around a circumference of the hub 141. With the stator assembly 10 fitted on the bearing cup seat 13, the filling material 12 is filled into the receiving space 111 of the casing 11 to enclose the circuit board 112. At this time, the coating 103 of the stator assembly 10 is in contact with and connected to the filling material 12 to seal the stator assembly 10 and the casing 11. Under such circumstance, impurities such as humidity and dust are prevented from infiltrating into the circuit board 112 and internal electronic components. Accordingly, the circuit board 112 and the internal electronic components are protected from damage. In the conventional technique, it is necessary to use a large amount of glue material and expend extra cost for making the mold. The motor protection structure of the present invention is free from these shortcomings so that the manufacturing cost is lowered and the working time is shortened.

In conclusion, in comparison with the conventional technique, the present invention has the following advantages:

1. The manufacturing cost is lowered.

2. The working time is shortened.

3. The weight is reduced.

4. The heat can be easily dissipated.

The present invention has been described with the above embodiment thereof and it is understood that many changes and modifications in the above embodiment can be carried out without departing from the scope and the spirit of the invention that is intended to be limited only by the appended claims.

What is claimed is:

1. A motor protection structure comprising:
a stator assembly having multiple silicon steel sheets and multiple windings, the stator assembly being coated with a coating;
a casing having a receiving space for receiving a circuit board electrically connected to the windings, the stator assembly being fitted on one side of the casing; and
a filling material filled in the receiving space to enclose the circuit board, the filling material being connected to the coating to seal the stator assembly and the casing.

2. The motor protection structure as claimed in claim 1, wherein the coating is formed and coated on the stator assembly by means of physical vapor deposition or chemical vapor deposition.

3. The motor protection structure as claimed in claim 2, wherein the physical vapor deposition is selected from a group consisting of vacuum evaporation, sputtering evaporation and ion evaporation.

4. The motor protection structure as claimed in claim 1, wherein the filling material is selected from a group consisting of silicone, polyurethane, epoxy resin, liquid, fluid material and waterproof material.

5. The motor protection structure as claimed in claim 1, wherein the casing is made of polymer material.

6. The motor protection structure as claimed in claim 1, further comprising a bearing cup seat disposed on the other side of the casing, which side is distal from the stator assembly.

7. The motor protection structure as claimed in claim 1, further comprising a fan impeller capped on the stator assembly, the fan impeller having a hub and multiple blades annularly arranged around a circumference of the hub.
